(19) United States
(12) Patent Application Publication
(10) Pub. No.: US 2019/0164286 A1
(43) Pub. Date: May 30, 2019

(54) INFORMATION PROCESSING APPARATUS, INFORMATION PROCESSING METHOD, AND NON-TRANSIENT COMPUTER READABLE STORAGE MEDIUM

(71) Applicant: CANON KABUSHIKI KAISHA, Tokyo (JP)

(72) Inventor: Yohei Hashizume, Tokyo (JP)

(21) Appl. No.: 16/198,646

(22) Filed: Nov. 21, 2018

(30) Foreign Application Priority Data
Nov. 28, 2017 (JP) 2017-228153

(51) Int. Cl. G06T 7/00; G06T 7/11; G06T 11/60; G06T 1/00

(52) U.S. Cl. CPC G06T 7/0014; G06T 7/11; G06T 2207/10132; G06T 1/0007; G06T 2207/10088; G06T 11/60

(57) ABSTRACT

A first region of interest (ROI) image including a first region of interest in a first medical image and a second ROI image including a second region of interest in a second medical image are acquired, a third ROI image is generated based on the first ROT image and the second ROI image, and a third medical image and the third ROI image are superimposed on each other on a display unit.

### BACKGROUND

### Field of the Disclosure

The disclosure of the specification relates to an information processing apparatus, an information processing method, and a non-transient computer readable storage medium.

### Description of the Related Art

In the observation of a medical image, a doctor may set a partial region to be observed with interest such as a lesion region as a region of interest (ROI) in the medical image.

Japanese Patent Laid-Open No. 2014-23921 discloses that, for the purpose of performing comparative radiogram interpretation of a plurality of medical images in an easy and simple manner, image data on regions of interest acquired from the medical image data is superimposed on other medical images or a plurality of medical images collected by heterogeneous modalities.

### SUMMARY

An information processing apparatus according to an embodiment of the present disclosure includes: an acquiring unit that acquires a first region of interest (ROI) image including a first region of interest in a first medical image and a second ROI image including a second region of interest in a second medical image different from the first medical image; a generation unit that generates a third ROI image based on the first ROI image and the second ROI image; and a display control unit that causes a display unit to superimpose a third medical image different from the first medical image and the second medical image on the third ROI image.

Further features of the present disclosure will become apparent from the following description of exemplary embodiments (with reference to the attached drawings).

### BRIEF DESCRIPTION OF THE DRAWINGS

FIGS. 1A to 1C are display examples of medical images according to a comparative example.

FIG. 2 is a block diagram illustrating an example of a functional configuration of an information processing apparatus according to one or more aspects of the present disclosure.

FIG. 3 is a flowchart of an example of a process performed by the information processing apparatus according to one or more aspects of the present disclosure.

FIGS. 4A and 4B are diagrams illustrating examples of screens displayed on the information processing apparatus according to one or more aspects of the present disclosure.

FIG. 5 is a flowchart of an example of a process performed by an information processing apparatus according to one or more aspects of the present disclosure.

FIG. 6 is a block diagram illustrating an example of a functional configuration of an information processing apparatus according to one or more aspects of the present disclosure.

FIG. 7 is a flowchart of an example of a process performed by an information processing apparatus according to one or more aspects of the present disclosure.

### DESCRIPTION OF THE EMBODIMENTS

### First Embodiment

As imaging techniques for displaying images based on volume data generated by a medical image capturing device (hereinafter, called modality), there are ultrasonic wave imaging, nuclear magnetic resonance imaging, and photoacoustic imaging.

In ultrasonic wave imaging, an ultrasonic wave is emitted to a subject and reflected by the subject, and the shape and behavior of a tissue are imaged based on the returned ultrasonic wave. More specifically, in ultrasonic wave imaging, a tissue different from surrounding tissues is imaged at a luminance different from those of the surrounding tissues, based on the magnitude of an echo signal of the ultrasonic wave emitted to the subject and reflected on the boundary between tissues in a living body. The image acquired by ultrasonic wave imaging will be hereinafter called ultrasound image. In relation to the present embodiment, as an example of an ultrasound image, descriptions will be given as to a B-mode image of a breast as a tomographic image formed by scanning the breast with an ultrasonic wave beam.

In nuclear magnetic resonance imaging (hereinafter, called MRI), the difference in magnetic characteristics between tissues is imaged by using a magnetic resonance phenomenon that is generated by irradiating a subject in a specific magnetic field with a radio wave. The image acquired by MRI will be hereinafter called MRI image. In relation to the present embodiment, as an example of an MRI image, descriptions will be given as to a tomographic image of a breast captured by MRI mammography using a gadolinium contrast agent.

In photoacoustic imaging, a living body is irradiated with pulsed light from a light source, a photoacoustic wave generated by a body tissue having absorbed the energy of the pulsed light propagated and diffused in the living body is detected, and the spatial distribution of the body tissue (optical absorber) having absorbed the energy of the pulsed light is imaged. In photoacoustic imaging, the differences in optical absorption rate between the region to be inspected such as a tumor and the other tissues are used to receive by a transducer an elastic wave (photoacoustic wave) that is generated when the region to be inspected absorbs the irradiation light energy and expands instantaneously. More specifically, in photoacoustic imaging, acquired is volume data indicating the three-dimensional spatial distribution of at least one kind of biological information such as the sound pressure of a photoacoustic wave (initial sound pressure), optical absorption energy density, optical absorption factor, and the concentration of a substance constituting a living body (such as oxygen saturation). Photoacoustic imaging makes it possible to obtain various types of images according to the optical characteristics of the inside of the subject. The image acquired by photoacoustic imaging will be hereinafter called photoacoustic image. For example, the photoacoustic image includes an absorption factor image indicating absorption density distribution. Generated from the absorption factor image is an image indicating the presence and proportions of biomolecules such as oxygenated hemoglobin, reduced hemoglobin, water, fat, and collagen. For example, based on the ratio of oxygenated hemoglobin and reduced hemoglobin, an image relating to the oxygen saturation as an index of the bonding state of hemoglobin and oxygen is obtained. In relation to the present embodiment, as an example of a photoacoustic image, a tomographic image of blood vessels in a breast will be described. In the following description, an ultrasonic wave and a photoacoustic wave will also be called acoustic wave.

In recent years, the various medical images described above and medical images for use in diagnosis, and various kinds of information relating to diagnosis have been electronized. For informational cooperation between the device capturing medical images and various types of devices connected to the image-capturing device, for example, Digital Imaging and Communications in Medicine (DICOM) standards are used in many cases. DICOM is standards that define formats for medical images and a communication protocol between the devices handling those images. Data to be exchanged under DICOM is called Information Object Definitions (IODs). In the following description, the information object definitions will be also called IODs or objects. Examples of IODs include medical images, patient information, inspection information, structured reports, and others. Various data relating to inspections and treatments using medical images can be IODs.

The images handled under DICOM, that is, the images as IODs are formed from incidental information and image data. The incidental information includes information relating to patients, inspections, series, and images, for example. The incidental information is formed from a collection of data elements called DICOM data elements. Each of the DICOM data elements is given a tag for identifying the data element. Pixel data (image data) as an example of DICOM data element is given a tag indicating image data. Each of the incidental information, for example, a patient's name is given a tag indicating a patient's name. When the incidental information and the image data are treated as a DICOM data set, the IOD may further include DICOM file meta-information for the DICOM data set. The DICOM file meta-information includes information on an application by which the IOD (DICOM file) was created, for example.

For example, a doctor observes a medical image of a breast and sets a portion deemed to be a tumor as a region of interest. In an image acquired by using a contrast agent, when the region of interest is a region of a tumor, the region of interest tends to be set to be larger than the actual region of the tumor in the living body. This is possibly because, in the region of the tumor, the contrast agent seeped from blood vessels of the tumor or the like to the surroundings. In addition, when ultrasound images collected by an ultrasonic wave diagnosis apparatus are used, a region of interest of the same degree of size as the tumor region tends to be set. However, in ultrasound images, the backward boundary of the tumor region may be blurred so that the region of interest may be set to be small.

In this way, depending on the situation in which a medical image is captured and the principles of the image capturing device, the region of interest may be represented in a medical image in different manners. There is a demand for further improvement so that the region of interest can be set with higher accuracy in such a case.

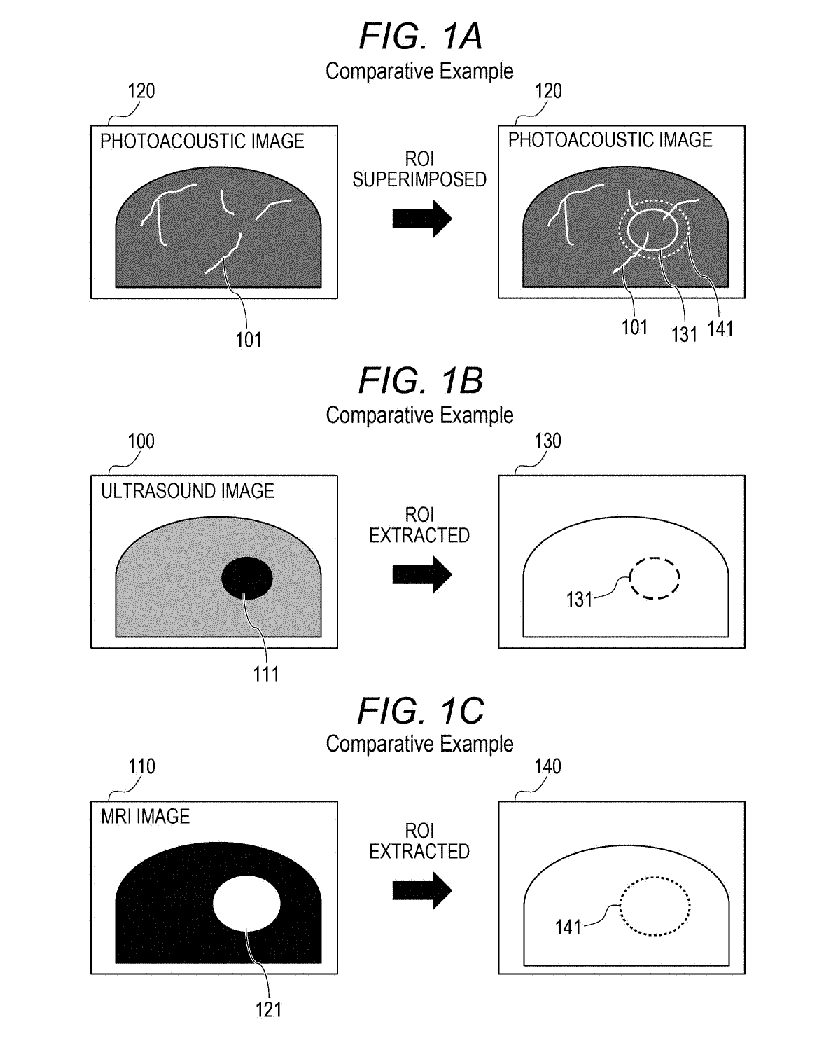

FIGS. 1A to 1C are diagrams illustrating an example of medical images of the same subject by different modalities. FIG. 1A illustrates a photoacoustic image 120 of a blood vessel 101. The blood vessel 101 is represented by the absorption factor of hemoglobin existing in the blood in the blood vessel as image luminance. FIG. 1B is an ultrasound image of a tumor 111. FIG. 1C is an MRI image of a tumor 121 emphasized by a contrast agent.

As can be seen from FIG. 1A, it may be difficult to determine the region of the tumor from only the photoacoustic image 120 of the blood vessel 101. This is because the photoacoustic image 120 may not reflect information on the tumor tissue in some cases. Accordingly, to find blood vessels resulting from angiogenesis around and inside the tumor by using the photoacoustic image 120, the photoacoustic image 120 may be compared to images of the tumor such as an ultrasound image 100 and an MRI image 110. Examples of methods for comparing a plurality of medical images include parallel display and superimposition of the plurality of medical images. For example, when the subject is a breast with breast cancer, a photoacoustic image of the inside of the breast and the blood vessels relating to the breast cancer, an ultrasound image of the tumor region of the breast cancer, and an MRI image are acquired. The acquired photoacoustic image 120 may be superimposed on the ultrasound image 100 or the MRI image 110 to complement each other's information. However, the luminances of these images interfere with each other so that the images may be deteriorated in visibility.

As another method, image data including the region of interest with respect to the tumor region in a medical image is generated and superimposed on the medical image. In relation to the present embodiment, the case where the ROI is a tumor region extracted from the medical image will be described as an example. In the following description, the image data including an ROI will be called ROI image. An ROI image 130 illustrated in FIG. 1B is volume data including an ROI 131, which is extracted from the region of a tumor 111 in the ultrasound image 100. An ROI image 140 illustrated in FIG. 1C is volume data including an ROI 141, which is extracted from the region of a tumor 121 in the MRI image 110.

In this case, the ROI 131 and the ROI 141 are generated from the tumor in the same living body but are different in the size of the ROI. Specifically, the ROI 141 is larger than the ROI 131. This is caused by the difference in features between the ultrasound image 100 and the MRI image 110. In the ultrasound image 100, the tumor 111 is imaged in the same degree of size as the actual tumor as described above in many cases. However, the boundary of the tumor in the ultrasound image is frequently blurred and wrongly detected. Specifically, the tumor 111 may be imaged in a smaller size than the actual tumor under influence of unevenness on the surface of the tumor. The tumor 111 in the ultrasound image 100 is an example of a tumor imaged in a smaller size than the actual tumor, and the ROI 131 is also smaller in size than the actual tumor. In the MRI image 110, the tumor 121 is frequently imaged in a larger size than the actual tumor. This is possibly because the contrast agent injected into the tumor seeped to the surrounding tissues with a lapse of time.

FIG. 1A illustrates an example in which the ROI 131 and the ROI 141 are superimposed on the photoacoustic image 120. As can be seen from the drawing, the two extracted ROIs of the same tumor are displayed in different sizes on the photoacoustic image 120. That is, when the user observes the photoacoustic image and the ROIs, for example, the size of the tumor to be observed in the photoacoustic image may look different for the doctor depending on the medical image used to generate the ROI images.

The information processing apparatus according to the present embodiment generates a new ROI based on the ROI extracted from the medical images acquired by a plurality of different modalities. Accordingly, an object of the present disclosure is to allow high-accuracy setting of ROIs even when there is a difference among a plurality of modalities in a mode in which a region to be set as an ROI is represented.

Embodiments will be described below with reference to the drawings. However, the dimensions, materials, shapes, and relative arrangements of components described below are to be changed as appropriate depending on the configuration and various conditions of the device to which the present disclosure is applied, and are not intended to limit the scope of the present disclosure to the following description.

In relation to a first embodiment, descriptions will be given as to an example of an information processing apparatus 200 that superimposes on a photoacoustic image an image indicating a third ROI generated from an intermediate value of a difference region between a first ROI and a second ROI.

<Configuration of the Information Processing Apparatus 200>

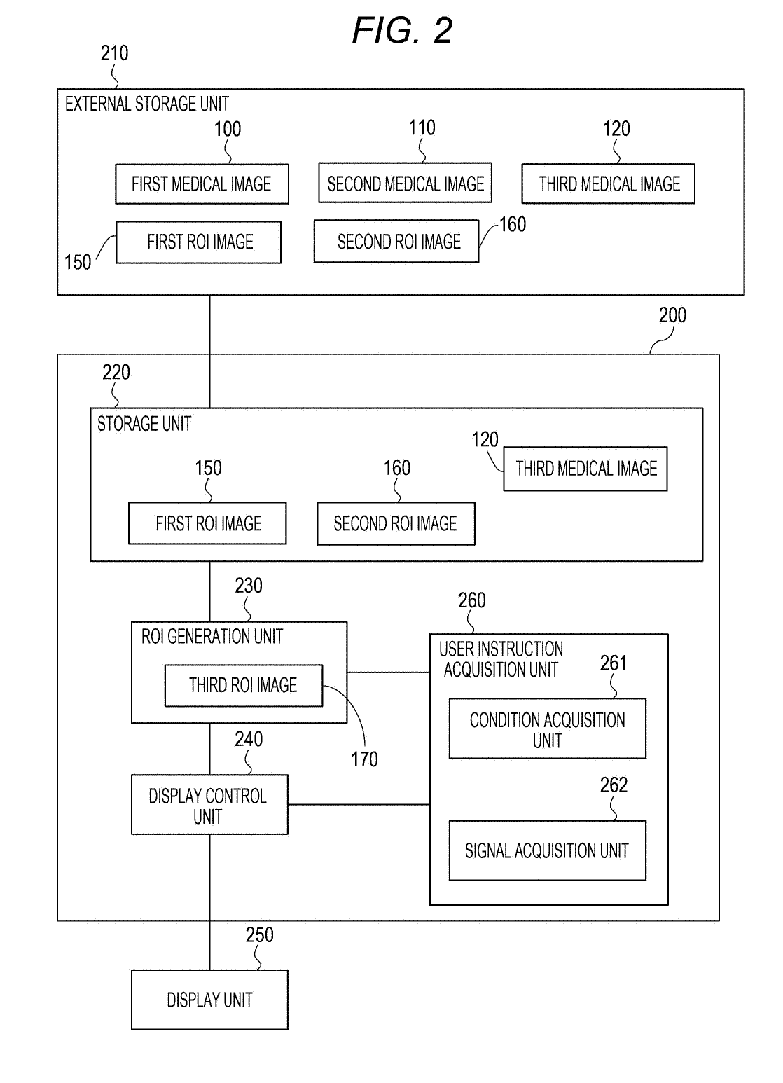

FIG. 2 is a diagram illustrating an example of a functional configuration of the information processing apparatus 200 according to the first embodiment. The information processing apparatus 200 has a storage unit 220, an ROI generation unit 230, a display control unit 240, and a user instruction acquiring unit 260. The information processing apparatus 200 is connected to an external storage unit 210 and a display unit 250.

<<External Storage Unit 210>>

The external storage unit 210 stores a plurality of medical images acquired by various modalities. The external storage unit 210 is arranged outside the information processing apparatus 200. In the present embodiment, the external storage unit 210 is formed from a recording medium such as a server and is connected to a communication network. The external storage unit 210 is a picture archiving and communication system (PACS), for example.

In the present embodiment, the external storage unit 210 stores at least a first medical image 100, a second medical image 110, and a third medical image 120 acquired by different modalities. The first medical image 100 is an ultrasound image, for example, the second medical image 110 is an MRI image, for example, and the third medical image 120 is a photoacoustic image, for example.

In the present embodiment, the first medical image 100, the second medical image 110, and the third medical image 120 are stored in conformity with the DICOM standards. These medical images show different body postures of a subject at the time of image capturing by the individual modalities and thus may have different positional information in some cases. In this case, the positional information can be aligned by performing a process for deforming at least one of the medical images. In the following descriptions, a process for deforming at least one of the medical images for alignment of the positional information will be called alignment. In the present embodiment, the first medical image 100, the second medical image 110, and the third medical image 120 are aligned in advance.

The external storage unit 210 also stores a first ROT image 150 and a second ROI image 160. The first ROI image 150 and the second ROI image 160 are ROI images generated by using medical images acquired by different modalities. In the present embodiment, the first ROI image 150 is an ROI image generated using the first medical image 100, and the second ROI image 160 is an ROI image generated using the second medical image 110. In the present embodiment, the first ROI image 150 and the second ROI image 160 are stored as volume data including ROIs and generated based on the aligned medical images. That is, in the present embodiment, the first ROI image 150 and the second ROI image are the same in volume size as the first medical image 100 and the second medical image 110 and have only ROI information stored in the volume.

In the present embodiment, the first ROI image 150 and the second ROI image 160 are stored in conformity with the DICOM standards. The first ROI image 150 may have incidental information of the first medical image 100 as medical information used for generation of the first ROI image 150. For example, the first ROI image 150 may have information on the modality that acquired the first medical image 100 as incidental information. The modality information of the biological information images from the respective extraction sources can be stored in the images. For example, when the first ROT image 150 and the second ROI image 160 are DICOM images, the modality information as a data element corresponding to an arbitrary tag number can be included in header information of the DICOM images. The user can refer to the header information to check the modality information of the biological information image from the extraction source of the ROI image.

<<Storage Unit 220>>

The storage unit 220 is formed from recording media such as a hard disc and a flash memory. The storage unit 220 captures and saves medical images and ROI images from the external storage unit 210 via a communication network. In the present embodiment, the storage unit 220 acquires from the external storage unit 210 a third medical image 120 that is selected as an observation target by a user such as a doctor and ROI images (the first ROI image 150 and the second ROI image 160) specified by the user. The storage unit 220 may output data and files stored therein to the external storage unit 210 in response to the user's operational input.

<<ROI Generation Unit 230>>

The ROI generation unit 230 generates a third ROI image 170. The unit performing an image processing function as the ROI generation unit 230 is formed from processors such as a CPU and a graphics processing unit (GPU), and an arithmetic operation circuit such as a field programmable gate array (FPGA) chip. These units may not be necessarily formed from a single processor and arithmetic operation circuit but may be formed from pluralities of processors and arithmetic operation circuits. The processor described in the present embodiment may include an FPGA.

The ROI generation unit 230 generates the third ROI image 170 based on the first ROI image 150 and the second ROI image 160. The ROI generation unit 230 acquires an ROI image corresponding to the medical image selected by the user. The ROI generation unit 230 generates the third ROI image 170 from a difference region between the acquired first ROI image 150 and second ROI image 160. In the present embodiment, the ROI generation unit 230 generates the third ROI image 170 based on an intermediate value of the difference region. For example, the intermediate value is determined by drawing a line radially from the centroid of the first ROI image and obtaining the midpoint of a line segment crossing the outer edge of the first ROI image and the outer edge of the second ROI image. Alternatively, the intermediate value may be determined by drawing a line radially from the centroid of the second ROI image and obtaining the midpoint of a line segment crossing the outer edge of the second ROI image and the outer edge of the first ROI image. In another embodiment, in a difference region obtained by subtracting the first ROI image from the second ROI image, the ROI generation unit 230 determines the midpoints of the line segments from the respective points of the outer edge of the first ROI image to the points where the normal lines from these points cross the outer edge of the second ROI image, as intermediate values. The surface formed from the midpoints constitutes the outer edge of the third ROI image. In the present embodiment, the third ROI image is an annotation image having only the outer edge generated based on the intermediate values.

The ROI generation unit 230 may generate the third ROI image 170 based on a user's condition accepted by a condition acquiring unit 261. In addition, the third ROI image 170 generated by the ROI generation unit 230 may be saved in the storage unit 220. The third ROI image 170 may be saved in association with the third medical image on which the third ROI image 170 is to be superimposed or may be saved in association with at least one of the first ROI image 150 and the second ROI image 160 used for generation of the third ROI image.

<<Display Control Unit 240>>

The display control unit 240 is formed from an integrated circuit or a video random access memory (RAM), and others. Upon reception of signals indicating user instructions from a signal acquiring unit 262, the display control unit 240 controls the display of medical images to be displayed on the display unit 250 and ROI images to be superimposed on the medical images. The display control unit 240 may also cause the display unit 250 to display a GUI for operating the images based on the volume data.

<<Display Unit 250>>

The display unit 250 is a display such as a liquid crystal display, an organic electro luminescence (EL), a field emission display (FED), an eyeglass-type display, or a head-mount display, for example. The display unit 250 is connected to the information processing apparatus 200. The display unit 250 displays the medical images and the ROI images under control of the display control unit 240.

<<User Instruction Acquiring Unit 260>>

The user instruction acquiring unit 260 includes the condition acquiring unit 261 and the signal acquiring unit 262. The condition acquiring unit 261 acquires conditions for the ROI generation unit 230 to generate the third ROI image 170 and user inputs relating to the contents of display controlled by the display control unit 240. The condition acquiring unit 261 saves text files and others describing these conditions, for example. In another embodiment, the condition acquiring unit 261 may cause the display unit 250 via the display control unit 240 to display a GUI for the user to input conditions.

The signal acquiring unit 262 acquires signals to be input by the user via an input unit (not illustrated). The input unit (not illustrated) is an input unit such as mouse, keyboard, touch panel, joystick, switch box, microphone receiving sounds including voice, and input unit accepting specific gestures, for example. The input unit (not illustrated) is connected to the information processing apparatus 200.

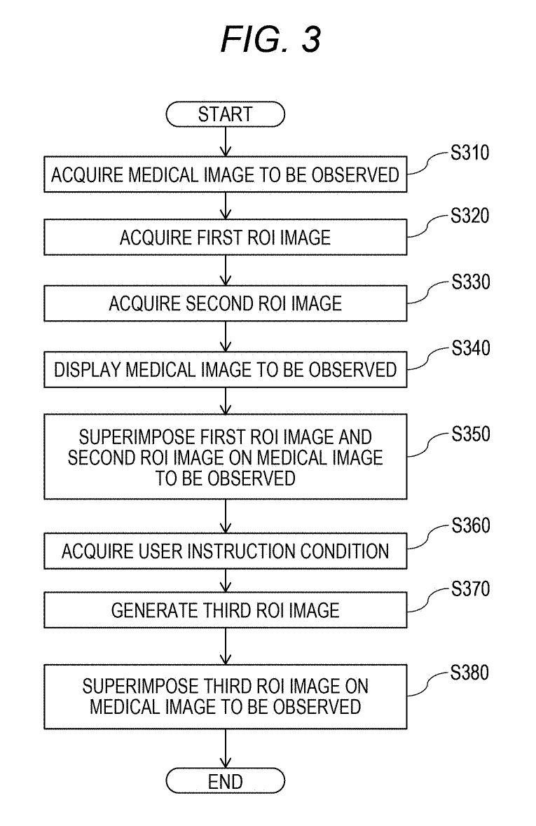

FIG. 3 is a flowchart of an example of a process performed by the information processing apparatus 200.

(S310: Step of Acquiring a Medical Image to be Observed)

The storage unit 220 acquires a medical image from the external storage unit 210 based on the user's selection. In the present embodiment, the user selects the third medical image 120 that is a photoacoustic image as an observation target.

(S320: Step of Acquiring the First ROI Image)

The storage unit 220 acquires volume data including an ROI generated based on the first medical image 100 that is an ultrasound image, as the first ROI image 150, according to the user's selection. The first ROI image 150 may be an image including a plurality of consecutive tomographic images.

(S330: Step of Acquiring the Second ROI Image)

The storage unit 220 acquires volume data including an ROI generated based on the second medical image 110 that is an MRI image as the second ROI image 160 according to the user's selection. The second ROI image 160 may be an image including a plurality of consecutive tomographic images.

(S340: Step of Displaying the Medical Image)

The third medical image 120 acquired in step S310 is displayed by the display control unit 240 on the display unit 250. When the user performs an operational input via the input unit (not illustrated), the signal acquiring unit 262 may acquire a signal indicative of the operational input and input the signal to the display control unit 240 so that the display of the medical image 100 on the display unit 250 can be controlled.

(S350: Step of Superimposing the First ROI Image and the Second ROI Image on the Medical Image to be Observed)

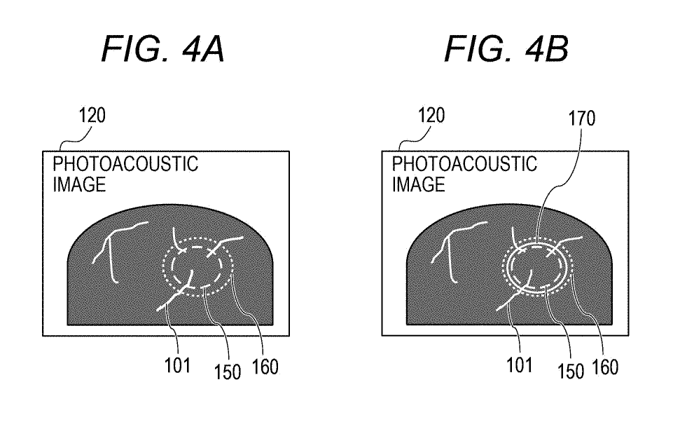

The first ROI image 150 and the second ROI image 160 acquired in step S320 are superimposed by the display control unit 240 on the third medical image 120 displayed on the display unit 250. FIG. 4A illustrates a display example of the first ROI image 150 and the second ROI image 160 superimposed on the third medical image 120 as a photoacoustic image. In this example, the superimposed first ROI image 150 and second ROI image 160 are annotation images illustrating only the contours of the ROIs. The first ROI image 150 and the second ROI image 160 may be superimposed by the signal acquiring unit 262 acquiring a user's operational input and inputting a signal to the display control unit 240.

(S360: Step of Acquiring a User Specified Condition)

The condition acquiring unit 261 acquires a condition for generating the third ROI image 170 as a user specified condition based on a user's operational input. The third ROI image 170 is generated from the difference region between the first ROI image 150 and the second ROI image 160. The user can input a user specified condition indicating which of the images to be set as an original image and which of the images to be subtracted, into the information processing apparatus 200. The user can check the relationship between the two ROI images displayed on the display unit 250 and input a user specified condition. The user can also input the position of the third ROI image 170 in the difference region as a user specified condition. The display control unit 240 can also cause the display unit 250 to display the modality information of the first ROI image 150 and the second ROI image 160 so that the user can check the modality information and input the position of the third ROI image 170 as a user specified condition.

In relation to the present embodiment, descriptions will be given as to an example of a case in which the intermediate value of the difference region obtained by subtracting the first ROI image 150 from the second ROI image 160 is set as the position of the third ROI image 170. The conditions for generation of the third ROI image 170 are not limited to the foregoing ones. For example, the third ROI image 170 may be a belt-shaped region in which the first ROI image 150 is subtracted from the second ROI image 160.

(S370: Step of Generating the Third ROI Image)

The ROI generation unit 230 generates the third ROI image 170 based on the ROI images acquired in steps S320 and S330 and the user specified condition acquired in step S360. In one embodiment, the generated third ROI image 170 is volume data that is the same in volume size as the medical images 100 to 130. The third ROI image 170 may be an image including a plurality of consecutive tomographic images. In addition, the third ROI image 170 may have information on the images used for generation of the third ROI image 170 in the incidental information or the image (for example, as an annotation). For example, when the third ROI image 170 is a DICOM image, the information on the images used for generation can be stored as a data element corresponding to an arbitrary tag number in the header information of the DICOM image.

(S380: Step of Superimposing the Third ROI Image on the Medical Image to be Observed)

The display control unit 240 superimposes the third ROI image 170 generated in step S370 on the medical image 130. FIG. 4B illustrates a display example of superimposition of the third ROI image 170 on the display illustrated in FIG. 4A. The signal acquiring unit 262 may superimpose the third ROI image 170 by acquiring a signal indicating a user's operational input via the input unit (not illustrated) and inputting the same into the display control unit 240.

As described above, the information processing apparatus 200 according to the first embodiment superimposes the third ROI image 170 generated based on the first ROI image 150 and the second ROI image 160 on the third medical image 120 as a medical image to be observed. That is, even when the ROIs are different in size due to the differences of modalities that acquired the medical images, the information processing apparatus 200 can set the ROIs with accuracy and suggest the same as ROI images to the user. The user can check the position of the ROI regarded as being closer to the actual tumor region by the ROI images.

### Second Embodiment

An information processing apparatus 200 according to a second embodiment superimposes a plurality of ROI images on a medical image to be observed and changes ROI images to be displayed in response to instructions from the user.

The functional configuration and hardware configuration of the information processing apparatus 200 according to the second embodiment are the same as those described above in relation to the first embodiment, and thus detailed descriptions thereof will be omitted by incorporating the foregoing descriptions.

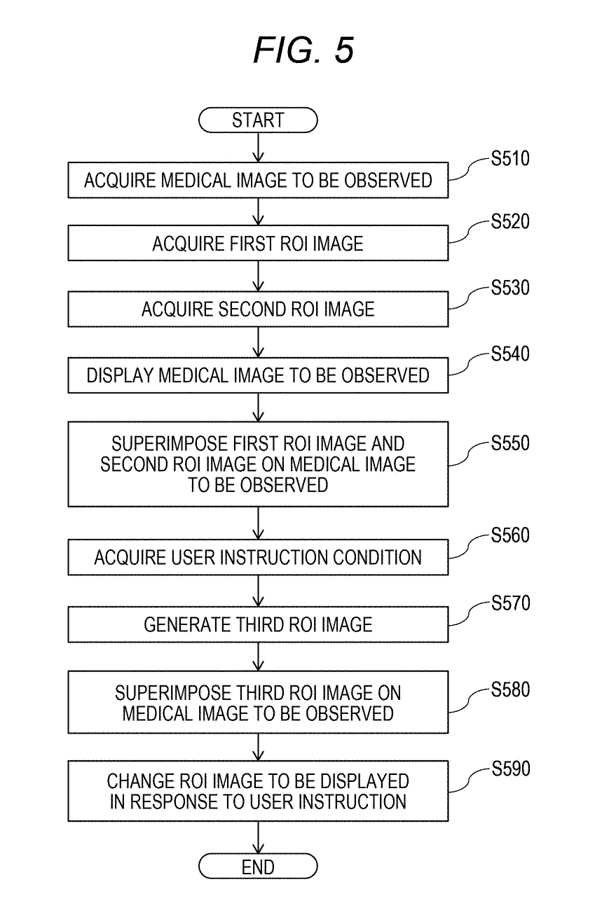

FIG. 5 is a flowchart of an example of a process performed by the information processing apparatus according to the present embodiment. Steps S510 to S580 are the same as steps S310 to 380 described in FIG. 3 and thus detailed descriptions thereof will be omitted by incorporating the foregoing descriptions. The present embodiment is different from the first embodiment in adding step S590 to change ROI images to be displayed in response to a user's instruction.

(S590: Step of Changing ROI Images to be Displayed in Response to a User's Instruction)

The display control unit 240 changes ROI images to be superimposed on a medical image to be observed in response to a user's operational input. More specifically, the display control unit 240 changes and superimposes any one of the first ROI image 150, the second ROI image 160, and the third ROI image 170 on the third medical image 120 in response to a user's operational input. The user makes an operational input via the input unit (not illustrated), and the signal acquiring unit 262 acquires a signal indicating the operational input and inputs the same into the display control unit 240. The display control unit 240 changes the ROI images to be displayed on the display unit 250 according to the signal input from the signal acquiring unit 262. In one embodiment, the input unit (not illustrated) is a mouse that has a button to which a display change function is allocated. For example, an ROI image hiding function can be allocated to the left button of the mouse and an ROI image showing function can be allocated to the right button of the mouse. The signal acquiring unit 262 acquires a signal along with the click of the left button of the mouse, and the display control unit 240 hides the ROI image displayed on the display unit 250 at the time of the click. The signal acquiring unit 262 also acquires a signal along with the click of the right button of the mouse, and the display control unit 240 causes the display unit 250 to display an ROI image different from the ROI image displayed at the time of the click. For example, at each right click, the display control unit 240 causes the display unit 250 to display the third ROI image 170, the first ROI image 150, and the second ROI image 160 such that these images are changed in this order. When no ROI image is displayed at the time of a click, the display control unit 240 causes the display unit 250 to display the ROI image at the time of a hiding process. As a method for hiding the ROI image, the display control unit 240 may perform fade-out display in which display luminance is reduced within a predetermined time. At this time, the condition acquiring unit 261 can acquire the condition of the time necessary for fade-out input by the user as a user specified condition. In another embodiment, the signal acquiring unit 262 may cause the display unit 250 to display a GUI, and the display control unit 240 may change ROI images to be displayed based on an operational input via the GUI.

As described above, the information processing apparatus 200 according to the second embodiment changes the display of the ROI images regarding the positions of the ROIs acquired by a plurality of different modalities and the position of the ROI closer to the actual tumor region in the generated ROI images. Accordingly, the user such as a doctor can observe a medical image to be observed without superimposing the ROI images on the medical image, and can check the relationship between the plurality of ROI images and the medical image to be observed by superimposing the desired ROI images.

### Third Embodiment

An information processing apparatus 200 according to a third embodiment sets the third ROI image as a belt-shaped area generated by the difference between the first ROI image and the second ROI image, and acquires a diagnostic index from the medical image displayed in the image region and displays the same.

<Configuration of the Information Processing Apparatus>

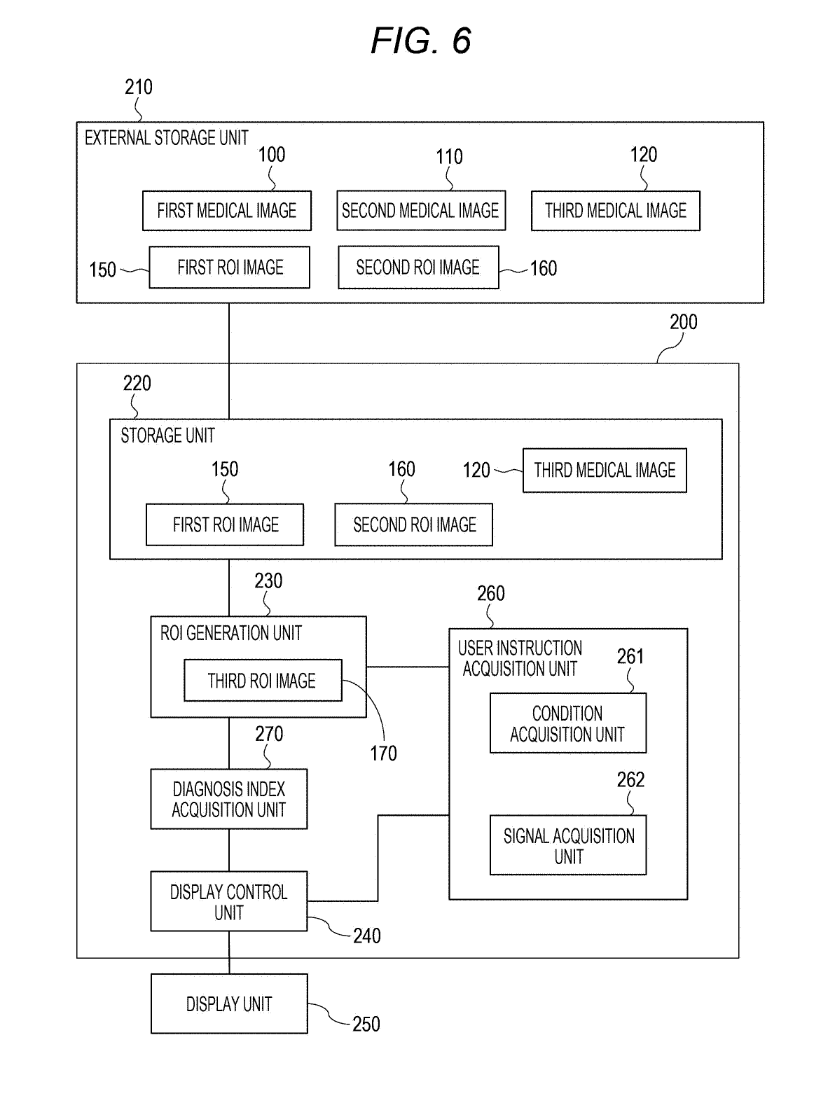

FIG. 6 is a diagram illustrating an example of a functional configuration of the information processing apparatus according to the present embodiment. The functional components of the present embodiment identical to those of the first embodiment and the second embodiment will be given as the same reference signs as those in FIG. 2 and detailed descriptions thereof will be omitted by incorporating the foregoing descriptions. The present embodiment is different from the first embodiment and the second embodiment in including a diagnostic index acquiring unit 270.

<<ROI Generation Unit 230>>

The ROI generation unit 230 generates the third ROI image 170 based on the first ROI image 150 and the second ROI image 160. In the third embodiment, the third ROI image is volume data having a belt-shaped region that is generated from the difference between the first ROI image and the second ROI image. The belt-shaped image region is a region that includes the peripheral portions on the outside of the tumor and the inside of the tumor centered on the boundary of the actual tumor.

<<Diagnostic Index Acquiring Unit 270>>

The diagnostic index acquiring unit 270 acquires a diagnostic index that aids doctors in making a diagnosis through image processing on a medical image to be observed. The diagnostic index acquiring unit 270 is formed from processors such as a CPU and a graphics processing unit (GPU), and an arithmetic operation circuit such as a field programmable gate array (FPGA) chip. The diagnostic index acquiring unit 270 may be integrated with the ROI generation unit 230.

In the case of using a photoacoustic image as a medical image to be observed, the number of blood vessels existing in the region of the third medical image 120 equivalent to the image region of the third ROI image 170 can be acquired as a diagnostic index, for example. The diagnostic index acquiring unit 270 extracts blood vessels from the photoacoustic image and counts the number of the extracted blood vessels as a diagnostic index. In one embodiment, the diagnostic index acquiring unit 270 acquires blood vessel distribution information in the region of the third medical image 120 that is equivalent to the image region of the third ROI image 170 as a diagnostic index. The blood vessel distribution information is information that indicates the degree of density of blood vessels in the region of the third medical image 120 equivalent to the image region of the third ROI image 170, for example. In one embodiment, the diagnostic index acquiring unit 270 acquires information on the diameters of the acquired blood vessels as a diagnostic index.

It is known that, around a tumor, blood vessels are generated by angiogenesis and clustered toward the tumor. In addition, it is known that the diameters of the blood vessels become narrower from the periphery of the tumor to the inside of the tumor. According to the diagnostic index regarding the number of blood vessels, the malignancy of the tumor (ROI) is considered as higher with increase in the number of the blood vessels. When the number of the blood vessels is larger than a predetermined value, according to the diagnostic index regarding the diameters of the blood vessels, the malignancy of the tumor (ROI) is considered as higher with increase in the thinness of the blood vessels.

In one embodiment, the diagnostic index acquiring unit 270 acquires the oxygen saturation of the blood vessels as a diagnostic index, based on an oxygen saturation image that is a photoacoustic image. Examples of the diagnostic index includes the oxygen saturation of one each blood vessel, the frequency of the number of blood vessels by oxygen saturation, the oxygen saturation distribution information in the region of the third ROI image 170, and others. It is known that, since a tumor actively takes in oxygen, the oxygen saturation tends to be low around the tumor. According to the diagnostic index regarding the oxygen saturation, it is considered that the malignancy of the tumor (ROI) is higher as the oxygen saturation is lower in the peripheral region of the tumor, that is, the region of the third ROI image. The foregoing diagnostic indexes are mere examples. The diagnostic index is not limited to the foregoing examples. The third ROI image 170 in the present embodiment has an image region that includes a region where the blood vessel change described above is likely to occur.

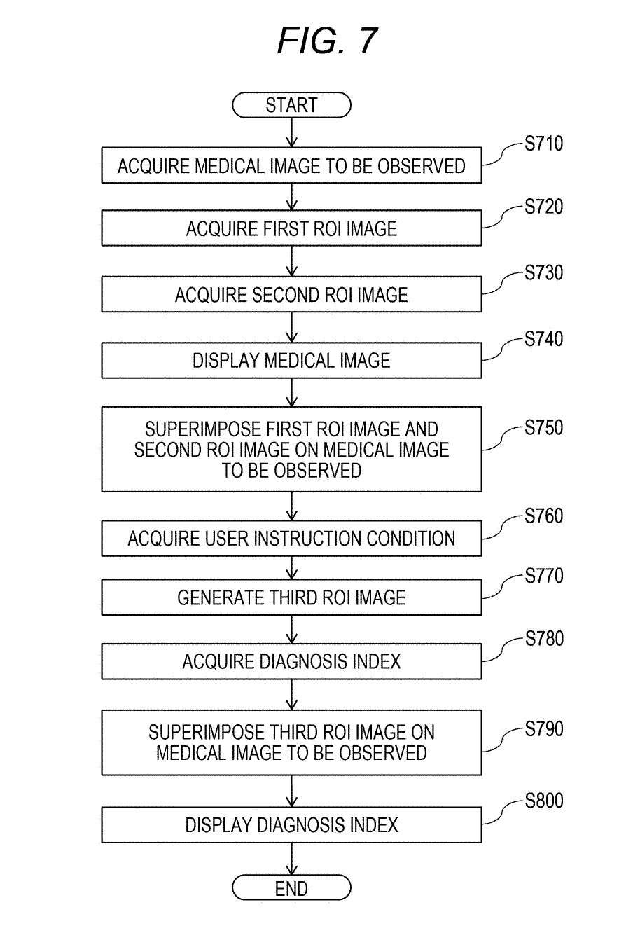

FIG. 7 is a flowchart of an example of a process performed by the information processing apparatus 200 according to the third embodiment. Steps S710 to S760 are the same as steps S310 to 360 described in FIG. 3 and step S790 is the same as step S380, and thus detailed descriptions thereof will be omitted by incorporating the foregoing descriptions.

(S770: Step of Generating the Third ROI Image)

The ROI generation unit 230 generates the third ROI image 170 from the difference region between the first ROI image 150 and the second ROI image 160. In the present embodiment, the third ROI image 170 has a belt-shaped image region.

(S780: Step of Acquiring a Diagnostic Index)

The diagnostic index acquiring unit 270 acquires a diagnostic index from the region of the third medical image 120 that is equivalent to the image region of the third ROI image 170. In relation to the present embodiment, descriptions will be given as to a case where the diagnostic index acquiring unit 270 acquires the number of blood vessels and distribution information in the image region. When the user adds the oxygen saturation image to the third medical image 120 as a photoacoustic image, the diagnostic index acquiring unit 270 may also acquire the oxygen saturations corresponding to the acquired blood vessels.

(S800: Step of Displaying a Diagnostic Index)

The display control unit 240 displays the diagnostic index acquired in step S780 on the display unit 250. In the present embodiment, the display control unit 240 superimposes the diagnostic index on the third medical image 120. The display control unit 240 may display the number of acquired blood vessels outside the image region of the biological information image. The display control unit 240 may also display the number of acquired blood vessels as a histogram corresponding to the blood vessel diameters. The display control unit 240 may display the distribution information of the number of blood vessels in the form of a contour drawing on the third image region 170. In the present embodiment, when the oxygen saturation image is used as a photoacoustic image, the display control unit 240 may display the oxygen saturation distribution in the form of a contour drawing on the image region of the third ROI image 170.

In the case of displaying the contour drawing, the display control unit 240 may superimpose the third ROI image 170 (FIG. 4B) in the first embodiment. Accordingly, the user can check the diagnostic index in comparison with the position of the tumor.

Accordingly, the information processing apparatus 200 according to the third embodiment generates the third ROI image, and acquires and displays the diagnostic index based on the peripheral region of the tumor shown in the third ROI image.

### Variation Example

As examples of medical images, three kinds of images which are the ultrasound image, the MRI image, and the photoacoustic image have been described above. However, the target medical images of the present disclosure are not limited to them. The target medical images may be medical images acquired by using at least any of image capturing devices such as a computed tomography (CT) device, digital radiography, single photon emission CT (SPECT) device, positron emission tomography (PET) device, and fundus camera. The target lesion is not limited to a tumor but may be a lesion in any part of the subject.

The case of using the medical images acquired by different modalities as the first medical image, the second medical image, and the third medical image has been described above. However, the present disclosure is not limited to this. For example, medical images acquired by the same modality in different imaging techniques may be used. Medical images acquired by the same modality can be different in the manner of representing the region of interest such as a tumor, depending on whether a contrast agent was used or not and the difference in the technique of imaging an acquired signal. Therefore, the first medical image may be an MRI image captured using a contrast agent and the second medical image may be an MRI image captured without a contrast agent, and the first ROI image and the second ROI image may be acquired using these MRI images. In addition, the third medical image may be a CT image, for example, and the third medical image may be superimposed on the third ROI image acquired based on the first ROI image and the second ROI image. That is, the third medical image is a medical image acquired on a principle different from that of the first medical image and the second medical image.

The storage unit 220 may inquire of the external storage unit 210 as to whether any related ROI image is stored based on the incidental information included in the medical image (the third medical image) specified by the user, and acquire the applied ROI image from the external storage unit 210.

The ROI generation unit 230 may acquire the first medical image 100 via the storage unit 220 and generate the first ROI image 150 based on the acquired first medical image 100. The ROI generation unit 230 may also acquire the second medical image 110 via the storage unit 220 and generate the second ROI image 160 based on the acquired second medical image 110. The storage unit 220 may inquire of the external storage unit 210 as to whether the first ROI image 150 and the second ROI image 160 are stored based on the incidental information included in the third medical image. When it is found that there is any ROI image not stored in the external storage unit 210, the ROI generation unit 230 may generate the ROI image not stored in the external storage unit 210.

The process for generating an ROI image includes a process for segmentation of a region with a high possibility of a tumor from a medical image, for example. The ROI image stored in the external storage unit 210 and the ROI image generated by the ROI generation unit 230 may be generated by any of the methods described below. The segmentation is carried out by at least any of methods such as binary conversion or region expansion, methods using edges extracted by a spatial filter (Sobel filter or Laplacian of Gaussian filter), methods using a classifier or clustering by which it is determined whether each pixel is a region or a background by a statistic classifier or the like, methods using variable shape models such as Snakes, dynamic contour models, and level sets, and methods such as graph cut.

The case where the ROI image is volume data including an image of the tumor region extracted has been described above as an example. However, the present disclosure is not limited to this. The ROI image may be an annotation image indicating the tumor region. The annotation image may be volume data with a plurality of consecutive tomographic images. When the first ROI image 150 and the second ROI image 160 are expressed as annotation images, the ROI generation unit 230 generates the third ROI image 170 as an annotation image. To generate the annotation image as well, the ROI generation unit 230 generates the third ROI image based on the difference region between the first ROI image and the second ROI image.

The case where the condition acquiring unit 261 acquires the condition for the ROI generation unit 230 to generate a ROI image as a user specified condition has been described above. However, the present disclosure is not limited to this. For example, the information processing apparatus 200 may not acquire a user specified condition. The ROI generation unit 230 may compare the image regions indicating the ROIs in the aligned first ROI image and second ROI image to determine the difference region between the first ROI image and the second ROI image. Specifically, of the first ROI image and the second ROI image, the ROI generation unit 230 may subtract the smaller ROI image from the larger ROI image to determine the difference region. In another embodiment, the ROI generation unit 230 may determine the absolute value of the difference between the first ROI image and the second ROI image as the difference region.

From this point of view, the ROI generation unit 230 can be regarded as a comparison unit that compares the first region of interest included in the first medical image with the second region of interest included in the second medical image. In addition, the third ROI image can be regarded as information indicating the difference between the first region of interest and the second region of interest.

The ROI generation unit 230 may select the first ROI image 150 and the second ROI image 160 based on the incidental information of the medical images to be observed. For example, the ROI generation unit 230 may select the first ROI image 150 and the second ROI image 160 according to the type of the modality having acquired the medical image to be observed. Specifically, the ROI generation unit 230 may read the information on the type of the modality from the incidental information of the third medical image and select the first ROI image and the second ROI image. When the medical image to be observed is a photoacoustic image, the ROI generation unit 230 may select ROI images respectively based on the MRI image and the ultrasound image. The user may preset the modality of the medical image to be observed and the modalities of the ROI images to be selected, and the ROI generation unit 230 may select the ROI images based on the settings. In this example, the process of selection may include a process for the ROI generation unit 230 to make an inquiry to the external storage unit 210 and capture and acquire the applied data via the storage unit 220 based on the result of the inquiry.

When the acquired first ROI image and second ROI image are not aligned, the ROI generation unit 230 may perform an alignment process. In that case, the ROI generation unit 230 may acquire the first medical image 100 and the second medical image 110 to perform the alignment process. In addition, when the first ROI image, the second ROI image, and the third ROI image are not aligned, the ROI generation unit 230 may perform an alignment process. In that case, the ROI generation unit 230 superimposes the third ROI image on the aligned third medical image.

The alignment process is a process of aligning the positions of corresponding features of two images, which includes a process of acquiring a spatial transform function to map a position (coordinates) on one image to a position (coordinates) on the other image.

In relation to the foregoing embodiments, the case where the first ROI image and the second ROI image are both three-dimensional images generated from medical images has been described as an example. However, the present disclosure is not limited to this. The first ROI image may be data indicating the coordinates of the region of interest in the first medical image, and the second ROI image may be data indicating the coordinates of the region of interest in the second medical image. The “first ROI image” and the “second ROI image” herein include the meaning of data indicating the respective coordinates of the region of interests. That is, the ROI image constitutes information indicating the region of interest.

Step S350 in the first embodiment, step S550 in the second embodiment, and step S750 in the third embodiment are not essential steps. In addition, the order of steps S320 to S340 in the first embodiment is not limited to the example illustrated in FIG. 3 but these steps may be performed in parallel or in an arbitrary order. The order of steps S520 to S540 in the second embodiment is not limited to the example illustrated in FIG. 5 but these steps may be performed in parallel or in an arbitrary order. The order of steps S720 to S740 in the third embodiment is not limited to the example illustrated in FIG. 7 but these steps may be performed in parallel or in an arbitrary order.

In relation to the foregoing embodiments, the case where the third ROI image is generated based on the two ROI images, the first ROI image and the second ROI image has been described as an example. However, the present disclosure is not limited to this. For example, the third ROI image may be generated by using only the first ROI image. In the case where the first medical image is an ultrasound image, there is a possibility that the first ROI image shows a region smaller than the actual region of interest. Accordingly, the ROI generation unit 230 generates an image indicating an enlarged region of the first ROI image as the third ROI image. The operator may preset the degree of the enlargement or may change arbitrarily the ROI image generated as an initial value. Similarly, as for the ROI image that may show a region larger than the actual region of interest such as a radiographic contrasting MRI image, the ROI generation unit 230 may reduce the ROI image as appropriate. In the case of generating the third ROI image by enlarging or reducing the first ROI image, the ROI generation unit 230 may generate the third ROI image such that the region shown by the first ROI image and the region of the enlarged or reduced margin can be differentiated from each other.

The information processing apparatuses in the foregoing embodiments may be implemented as single apparatuses or may be configured to execute the foregoing processes in combination with one another in a communicable manner. Both the configurations are included in the embodiments of the present disclosure. The foregoing processes may be executed by a common server device or a server group. The plurality of apparatuses constituting the information processing apparatus and the information processing system is at least communicable at a predetermined communication rate and does not need to exist in the same facility or the same country.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-228153, filed Nov. 28, 2017, which is hereby incorporated by reference herein in its entirety.

What is claimed is:

1. An information processing apparatus comprising:
an acquiring unit configured to acquire a first region of interest (ROI) image including a first region of interest in a first medical image and a second ROI image including a second region of interest in a second medical image different from the first medical image;
a generation unit configured to generate a third ROI image based on the first ROI image and the second ROI image; and
a display control unit configured to cause a display unit to superimpose a third medical image different from the first medical image and the second medical image on the third ROI image.

2. The information processing apparatus according to claim 1, wherein the generation unit generates the third ROI image based on a region of a difference between the first ROI image and the second ROI image.

3. The information processing apparatus according to claim 2, wherein the third ROI image is positioned in a middle between the first ROI image and the second ROI image.

4. The information processing apparatus according to claim 2, wherein the generation unit generates a belt-shaped region indicating the region of the difference between the first ROI image and the second ROI image as the third ROI image.

5. The information processing apparatus according to claim 1, wherein the display control unit superimposes the first ROI image, the second ROI image, and the third ROI image on the third medical image.

6. The information processing apparatus according to claim 1, wherein the display control unit is capable of changing the images to be superimposed on the third medical image based on a user's operational input.

7. The information processing apparatus according to claim 6, wherein the display control unit changes an image to be displayed from the third ROI image superimposed on the third medical image to one of the first ROI image and the second ROI image based on a user's operational input.

8. The information processing apparatus according to claim 1, wherein the acquiring unit acquires the first ROI image and the second ROI image from an external storage device.

9. The information processing apparatus according to claim 1, wherein
the acquiring unit inquires of an external storage device as to whether the first ROI image is stored,
when, as a result of the inquiry, it is found that the first ROI image is stored in the external storage device, the acquiring unit acquires the first ROI image from the external storage device, and
when, as a result of the inquiry, it is found that the first ROI image is not stored in the external storage device, the acquiring unit acquires the first medical image from the external storage device, and the generation unit generates the first ROI image from the acquired first medical image.

10. The information processing apparatus according to claim 1, comprising a diagnostic index acquiring unit configured to acquire a diagnostic index based on the third medical image that is equivalent to a third region of interest in the third ROI image.

11. The information processing apparatus according to claim 1, wherein
the first medical image is an ultrasound image that is captured based on a reflected wave of an ultrasonic wave emitted to a subject and reflected in the subject,
the second medical image is an MRI image that is captured based on a nuclear magnetic resonance phenomenon in the subject in a magnetic field, and
the third medical image is a photoacoustic image that is captured based on an acoustic wave obtained by irradiating the subject with light.

12. The information processing apparatus according to claim 1, wherein, when the third medical image is a photoacoustic image that is captured based on an acoustic wave obtained by irradiating a subject with light, the generation unit generates the third ROI image.

13. The information processing apparatus according to claim 1, wherein
when the third medical image is a photoacoustic image that is captured based on an acoustic wave obtained by irradiating a subject with light,
the acquiring unit acquires an ROI image that is generated from an ultrasound image captured based on a reflected wave of an ultrasonic wave emitted to the subject and reflected in the subject, as the first ROI image, and
the acquiring unit acquires an ROI image that is generated from an MRI image captured based on a nuclear magnetic resonance phenomenon to the subject in a magnetic field, as the second ROI image.

14. The information processing apparatus according to claim 1, wherein the generation unit sets a third region of interest in a region between the first region of interest and the second region of interest based on the first ROI image and the second ROT image, and generates the third ROI image including the third region of interest.

15. An information processing apparatus comprising:
a comparison unit configured to compare a first region of interest included in a first medical image with a second region of interest included in a second medical image different from the first medical image; and
a display control unit configured to cause a display unit to, based on a result of the comparison, superimpose information indicating a difference between the first region of interest and the second region of interest on the third medical image different from the first medical image and the second medical image.

16. An information processing method comprising:
acquiring a first ROI image including a region of interest in a first medical image and a second ROI image including a region of interest in a second medical image different from the first medical image;
generating a third ROI image based on the first ROI image and the second ROI image; and
superimposing a third medical image different from the first medical image and the second medical image on the third ROI image.

17. An information processing method comprising:
comparing a first region of interest included in a first medical image with a second region of interest included in a second medical image different from the first medical image; and
causing a display unit to, based on a result of the comparison, superimpose information indicating a difference between the first region of interest and the second region of interest on the third medical image different from the first medical image and the second medical image.

18. A computer readable non-transient storage medium storing a program for a computer to execute the information processing method according to claim 16.

19. A computer readable non-transient storage medium storing a program for a computer to execute the information processing method according to claim 17.
